(19) United States
(12) Patent Application Publication
(10) Pub. No.: US 2025/0337869 A1
(43) Pub. Date: Oct. 30, 2025

(54) CORRECTION METHOD, PROJECTOR, AND NON-TRANSITORY COMPUTER-READABLE STORAGE MEDIUM

(71) Applicant: Seiko Epson Corporation, Tokyo (JP)

(72) Inventor: Tetsuo MANO, Shiojiri-shi (JP)

(73) Assignee: Seiko Epson Corporation, Tokyo (JP)

(21) Appl. No.: 19/192,689

(22) Filed: Apr. 29, 2025

(30) Foreign Application Priority Data
Apr. 30, 2024 (JP) 2024-074020

(51) Int. Cl. H04N 9/31

(52) U.S. Cl. CPC H04N 9/3194; H04N 9/3191

(57) ABSTRACT

A correction method includes applying first geometric correction for correcting distortion of an image to be projected from a projector onto a first projection surface when a projection angle that is an angle between horizontal plane and projection direction of projector is an angle within a first range; applying second geometric correction for correcting distortion of an image to be projected from projector onto a second projection surface that intersects with first projection surface when projection angle is an angle within a second range different from the first range; applying the first geometric correction when the projection angle changes from an angle within the first range to an angle within a third range that is a range between the first range and the second range; and applying the second geometric correction when the projection angle changes from an angle within the second range to an angle within the third range.

The present application is based on, and claims priority from JP Application Serial Number 2024-074020, filed Apr. 30, 2024, the disclosure of which is hereby incorporated by reference herein in its entirety.

### BACKGROUND

### 1. Technical Field

The present disclosure relates to a correction method, a projector, and a non-transitory computer-readable storage medium storing a program.

### 2. Related Art

JP-A-2014-150380, for example, describes a projection apparatus capable of changing a projection direction of a projection unit that converts image data into light and projects the light. The projection apparatus described in JP-A-2014-150380 measures the distance to a projection receiving medium onto which the projection unit projects the light, acquires a first direction perpendicular to the projection receiving medium based on the measured distance, and performs image processing on the image data, the image processing being image processing according to a second direction as a result of correction of the projection direction of the projection unit using the first direction. In the process described above, a distortion correction coefficient used to perform the correction is switched from one to another when the angle of the projection crosses the intersection line of two projection receiving media that intersect with each other, such as a wall and a ceiling.

JP-A-2014-150380 is an example of the related art.

In the projection apparatus described in JP-A-2014-150380, when projection is performed in the vicinity of the intersection line of two projection receiving media that intersect with each other, the distortion correction coefficient could be undesirably frequently switched from one to another.

### SUMMARY

A correction method according to an aspect of the present disclosure includes: applying first geometric correction for correcting distortion of an image to be projected from a projector onto a first projection surface when a projection angle that is an angle between a horizontal plane and a projection direction of the projector is an angle within a first range; applying second geometric correction for correcting distortion of an image to be projected from the projector onto a second projection surface that intersects with the first projection surface when the projection angle is an angle within a second range different from the first range; applying the first geometric correction when the projection angle changes from an angle within the first range to an angle within a third range that is a range between the first range and the second range; and applying the second geometric correction when the projection angle changes from an angle within the second range to an angle within the third range.

A projector according to another aspect of the present disclosure includes: an optical apparatus; and at least one processor configured to apply first geometric correction for correcting distortion of an image to be projected from the optical apparatus onto a first projection surface when a projection angle that is an angle between a horizontal plane and a projection direction of the optical apparatus is an angle within a first range, apply second geometric correction for correcting distortion of an image to be projected from the optical apparatus onto a second projection surface that intersects with the first projection surface when the projection angle is an angle within a second range different from the first range, apply the first geometric correction when the projection angle changes from an angle within the first range to an angle within a third range that is a range between the first range and the second range, and apply the second geometric correction when the projection angle changes from an angle within the second range to an angle within the third range.

A non-transitory computer-readable storage medium storing a program according to another aspect of the present disclosure is configured to cause at least one processor to apply first geometric correction for correcting distortion of an image to be projected from a projector onto a first projection surface when a projection angle that is an angle between a horizontal plane and a projection direction of the projector is an angle within a first range, apply second geometric correction for correcting distortion of an image to be projected from the projector onto a second projection surface that intersects with the first projection surface when the projection angle is an angle within a second range different from the first range, apply the first geometric correction when the projection angle changes from an angle within the first range to an angle within a third range that is a range between the first range and the second range, and apply the second geometric correction when the projection angle changes from an angle within the second range to an angle within the third range.

### BRIEF DESCRIPTION OF THE DRAWINGS

FIG. 1 shows an overview of a system used to perform a correction method according to a first embodiment.

FIG. 2 is a block diagram of the projector according to the first embodiment.

FIG. 3 is a flowchart showing the procedure of the correction method according to the first embodiment.

FIG. 4 illustrates that geometric correction is switched from one to another in the first embodiment.

FIG. 5 illustrates a correction value.

FIG. 6 is a flowchart showing an example of a method for calculating the correction value.

FIG. 7 illustrates that the geometric correction is switched from one to another in a second embodiment.

### DESCRIPTION OF EMBODIMENTS

Preferable embodiments according to the present disclosure will be described below with reference to the accompanying drawings. Note in the drawings that the dimensions and scales of portions differ from the actual values as appropriate, and some of the portions are diagrammatically shown to facilitate understanding of the portions. Furthermore, the scope of the present disclosure is not limited to the embodiments unless particularly described to limit the present disclosure in the following description.

### 1. First Embodiment

### 1-1. Overview of System Used to Perform Correction Method

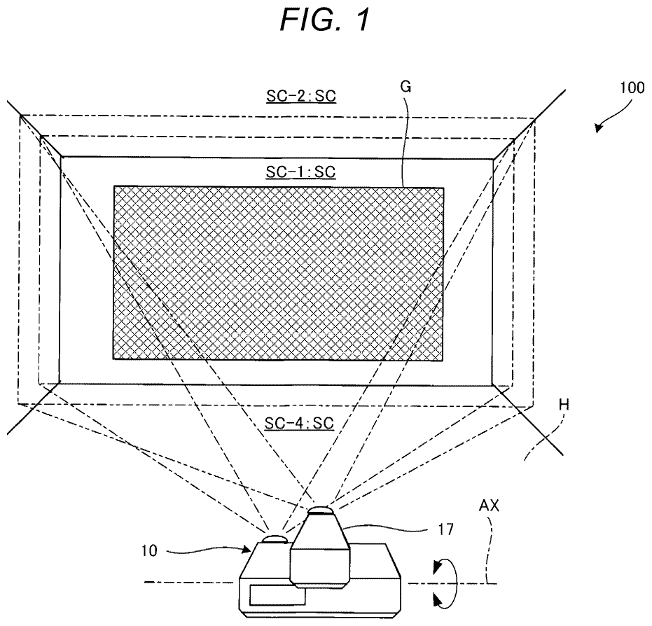

FIG. 1 shows an overview of a system 100 used to perform a correction method according to a first embodiment. The system 100 includes a projector 10, as shown in FIG. 1.

The projector 10 is a display apparatus that projects an image G, which is indicated by image information output from an instrument such as a computer that is not shown, onto a projection surface SC.

The posture of the projector 10 or an optical apparatus 15, which will be described later, around an axis AX can be changed. The axis AX is an axis perpendicular to the direction in which the projector 10 projects the image G. The rotation of the projector 10 or the optical apparatus 15, which will be described later, around the axis AX therefore changes a projection angle θ, which will be described later and is the angle between a horizontal plane H and the projection direction of the projector 10. The projection direction is, for example, a direction of the center line of image light output by the projector 10, the direction extending from the projector 10 toward the projection surface SC.

A method for changing the posture of the thus configured projector 10 is not particularly limited to a specific method, and may, for example, be a method using a table that supports the projector 10 or the optical apparatus 15, which will be described later, so as to be rotatable around the axis AX. As an example, the table includes a base disposed at an installation surface, and a pair of columns coupled to the base. The projector 10 is disposed between the pair of columns and linked to a rotary mechanism provided at the front ends of the columns. The projector 10 is thus supported rotatably around the axis AX. The rotary mechanism includes, for example, a shaft provided at one of the projector 10 and the columns, and a bearing provided at the other one of the projector 10 and the columns and rotatably supporting the shaft. The structure of the table is not limited to the structure described above, and a support plate at which the projector 10 is installed may be rotated by a similar rotary mechanism.

The posture of the projector 10 can be changed around the axis AX, so that the projector 10 can project the image G onto any projection surface SC of projection surfaces SC-1, SC-2, SC-3, and SC-4. The projection surface SC-1 is an example of a “first projection surface”, and the projection surface SC-2 is an example of a “second projection surface”. Note that FIG. 1 does not show the projection surface SC-3 for convenience of drawing. Hereinafter, the projection surfaces SC-1, SC-2, SC-3, and SC-4 may not be distinguished from each other but may be referred collectively to as projection surfaces SC.

The projection surface SC-1 is a surface parallel to the vertical direction, and is, for example, a wall surface or the surface of a screen or the like along the wall surface. The projection surface SC-2 is a surface that intersects with the projection surface SC-1, preferably, is perpendicular to the vertical direction, and is, for example, a ceiling surface or the surface of a screen or the like along the ceiling surface. The projection surface SC-3 is a surface that intersects with the projection surface SC-2 and faces the projection surface SC-1, and is, for example, a wall surface or the surface of a screen or the like along the wall surface. The projection surface SC-4 is a surface that intersects with the projection surfaces SC-1 and SC-3 and faces the projection surface SC-2, and is, for example, a floor surface or the surface of a screen or the like along the floor surface. Note that the projection surfaces SC-1, SC-2, SC-3, and SC-4 may each not be a planar surface in a strict sense, but are preferably a surface that can be regarded as a surface planar enough to simplify a process carried out to geometrically correct the image G.

The projector 10 corrects distortion of the image G produced due to the posture of the projector 10 around the axis AX by using geometric correction such as trapezoidal correction. In the geometric correction, for example, when the image G to be projected has a rectangular shape, the image G to be actually projected is corrected so as to have the rectangular shape.

As will be described later in detail, the projector 10 includes a sensor 17, and has the function of measuring the position and posture of the projector 10 with respect to the projection surface SC by using the sensor 17, and the function of determining a correction value for the geometric correction of the image G based on the result of the measurement.

### 1-2. Projector

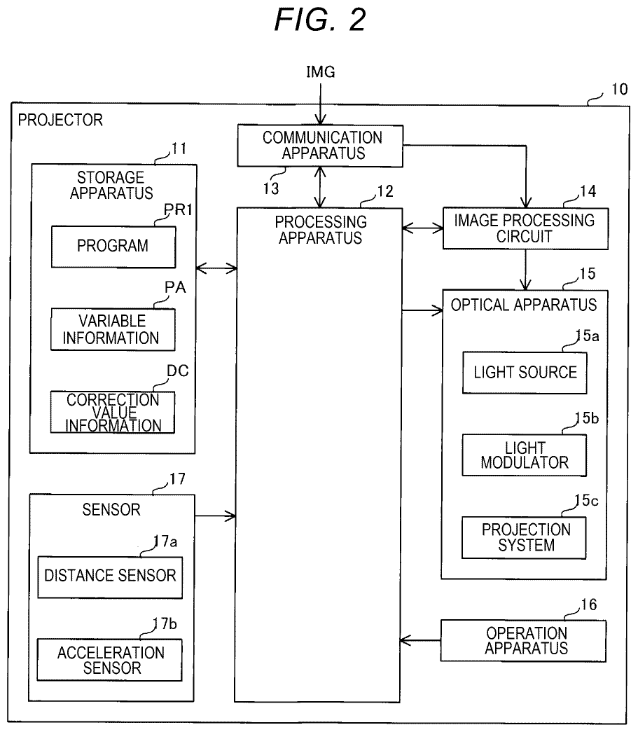

FIG. 2 is a block diagram of the projector 10 according to the first embodiment. The projector 10 includes a storage apparatus 11, a processing apparatus 12, a communication apparatus 13, an image processing circuit 14, the optical apparatus 15, an operation apparatus 16, and the sensor 17, as shown in FIG. 2. The apparatuses are communicatively connected to each other.

The storage apparatus 11 is a storage apparatus that stores programs to be executed by the processing apparatus 12 and data to be processed by the processing apparatus 12. The storage apparatus 11 includes, for example, a hard disk drive or a semiconductor memory. Note that a portion or the entirety of the storage apparatus 11 may be provided in a storage apparatus, a server, or the like outside the projector 10.

The storage apparatus 11 stores a program PR1, variable information PA, and correction value information DC.

The program PR1 is a program that performs a correction method, which will be described later in detail.

The variable information PA is information representing a variable of an arithmetic expression used to geometrically correct the image G, and indicates the degree of the geometric correction of the image G. The variable relates to at least one of the angle at which the projection surface SC is installed, the vector of a normal to the projection surface SC, and the posture of the projector 10. That is, the variable represents the angle between the projection surface SC and the projection direction.

The correction value information DC is information indicating the correction value of the geometric correction of the image G. The correction value are, for example, coordinate values of the four corners of the image G. The coordinate values are, for example, coordinate values of a display coordinate system set in the optical apparatus 15, which will be described later, or a coordinate system associated with the display coordinate system.

The processing apparatus 12 is a processing apparatus having the function of controlling each section of the projector 10 and the function of processing various data. For example, the processing apparatus 12 includes at least one processor such as a central processing unit (CPU). Note that some or all of the functions of the processing apparatus 12 may be realized by hardware such as a digital signal processor (DSP), an application specific integrated circuit (ASIC), a programmable logic device (PLD), and a field programmable gate array (FPGA). The processing apparatus 12 may be integrated with the image processing circuit 14.

The communication apparatus 13 is a communication apparatus that can communicate with various instruments, and acquires image data IMG from an instrument that is not shown. For example, the communication apparatus 13 is a wired communication apparatus using a wired LAN (local area network), a USB (universal serial bus), or an HDMI (high definition multimedia interface), or a wireless communication apparatus using an LPWA (low power wide area), a wireless LAN including Wi-Fi, or Bluetooth. “HDMI”, “Wi-Fi”, and “Bluetooth” are each a registered trademark.

The image processing circuit 14 is a circuit that performs necessary processing on the image data IMG from the communication apparatus 13 and inputs the processed data to the optical apparatus 15. The image processing circuit 14 includes, for example, one or more processors such as CPUs, or hardware such as a DSP, an ASIC, a PLD, or an FPGA. The image processing circuit 14 includes, for example, a frame memory that is not shown, loads the image data IMG into the frame memory, appropriately performs various kinds of processing such as resolution conversion, resizing, and distortion correction, and inputs the processed data to the optical apparatus 15. The correction value information DC is used in the geometric correction including the distortion correction. Note that the image processing circuit 14 may perform processing such as on-screen display (OSD) as necessary, in which image information used, for example, to display a menu or provide operation guidance is generated and combined with the image data IMG.

The optical apparatus 15 is an apparatus that displays the image G by projecting the image light onto the projection surface SC. The optical apparatus 15 includes a light source 15a, a light modulator 15b, and a projection system 15c.

The light source 15a includes a light source, for example, a halogen lamp, a xenon lamp, an ultrahigh-pressure mercury lamp, LEDs (light emitting diodes), or laser light sources, and outputs red light, green light, and blue light. The light modulator 15b includes three light modulating devices provided in correspondence with red, green, and blue. The light modulating devices include, for example, a transmissive liquid crystal panel, a reflective liquid crystal panel, or a digital micromirror device (DMD), and modulate light of the corresponding color to generate image light of the color. The multiple types of color image light generated by the light modulator 15b are combined with one another by a light combining system into full-color image light. The projection system 15c is an optical system including a projection lens and other elements that form an image of the full-color image light from the light modulator 15b and projects the image onto the projection surface SC.

The operation apparatus 16 is an apparatus that accepts a user's operation. For example, the operation apparatus 16 includes an operation panel and a remote control light receiver none of which is shown. The operation panel is provided as a portion of an exterior enclosure of the projector 10, and outputs a signal based on the user's operation. The remote control light receiver receives an infrared signal from a remote control that is not shown, decodes the infrared signal, and outputs a signal based on the operation performed on the remote control. Note that the operation apparatus 16 is provided as necessary and may be omitted.

The sensor 17 is a sensor that estimates the relative position and posture of the projector 10 with respect to the projection surface SC. The sensor 17 includes a distance sensor 17a and an acceleration sensor 17b. The distance sensor 17a is a time-of-flight (ToF) distance sensor and measures the distance between each of the projection surfaces SC and the projector 10. In other words, the distance sensor 17a measures the shape of each of the projection surfaces SC. The acceleration sensor 17b is a sensor that detects acceleration in each of three axes orthogonal to each other, and detects acceleration acting on the projector 10.

Note that the sensor 17 is not limited to that shown in FIG. 2 by way of example, only needs to be capable of producing a detection result necessary for estimating the relative position and posture of the projector 10 with respect to the projection surface SC, and may, for example, have an aspect in which one of the distance sensor 17a and the acceleration sensor 17b is omitted, or an aspect in which an inertial sensor such as an angular velocity sensor and a camera are provided in place of one or both of the distance sensor 17a and the acceleration sensor 17b. However, the detection result necessary for estimating the relative position and posture of the projector 10 with respect to the projection surface SC varies depending on the geometric correction calculation method and the like, and is not limited to a specific result.

In the projector 10 described above, the processing apparatus 12 executes the program PR1 stored in the storage apparatus 11 to carry out various processes necessary for the correction method described later.

### 1-3. Correction Method

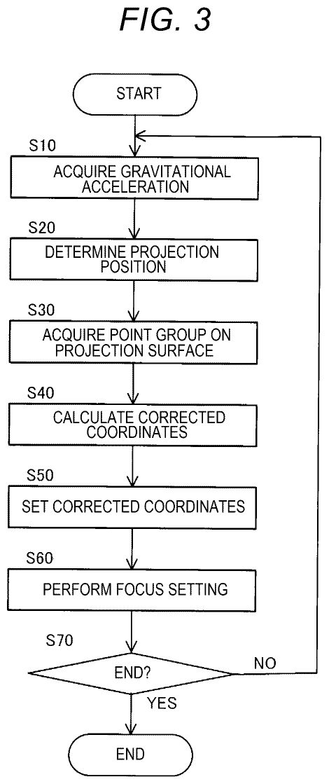

FIG. 3 is a flowchart showing the procedure of the correction method according to the first embodiment. The correction method according to the present embodiment includes steps S10 to S70, as shown in FIG. 3. The program PR1 causes the processing apparatus 12 to execute steps S10 to S70. The processing apparatus 12 and the image processing circuit 14 are examples of a “computer” and include at least one processor that executes steps S10 to S70.

First, in step S10, the processing apparatus 12 acquires gravitational acceleration acting on the projector 10 based on the result of the detection performed by the acceleration sensor 17b. Note that the gravitational acceleration may be calculated based on the result of statistical processing such as moving average of the results of the detection performed by the acceleration sensor 17b.

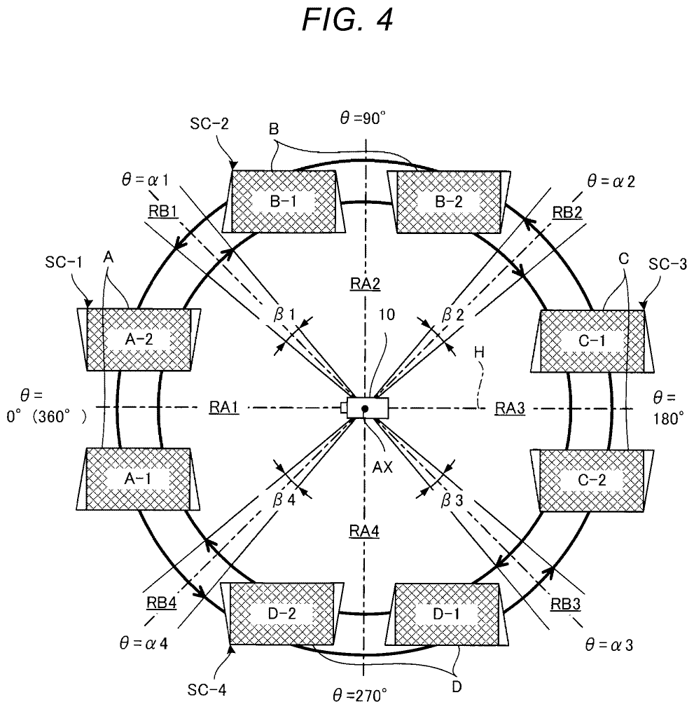

After step S10, the processing apparatus 12 determines in step S20 the projection position based on the direction of the gravitational acceleration acting on the projector 10. The determination is made by determination of the range within which a projection angle θ, which will be described later and estimated based on the direction of the gravitational acceleration, falls out of ranges RA1 to RA4 and RB1 to RB4, which will be described later. When the projection angle θ falls within any of the ranges RB1 to RB4, the processing apparatus 12 identifies the range within which the projection angle θ has fallen out of the ranges RA1 to RA4 immediately before the projection angle θ falls within the one of the ranges RB1 to RB4. Step S20 will be described later in detail with reference to FIG. 4.

After step S20, the processing apparatus 12 acquires in step S30 a point group on the projection surface SC based on the result of the detection performed by the distance sensor 17a. The point group is acquired, for example, in the form of coordinate values indicating multiple positions on the projection surface SC.

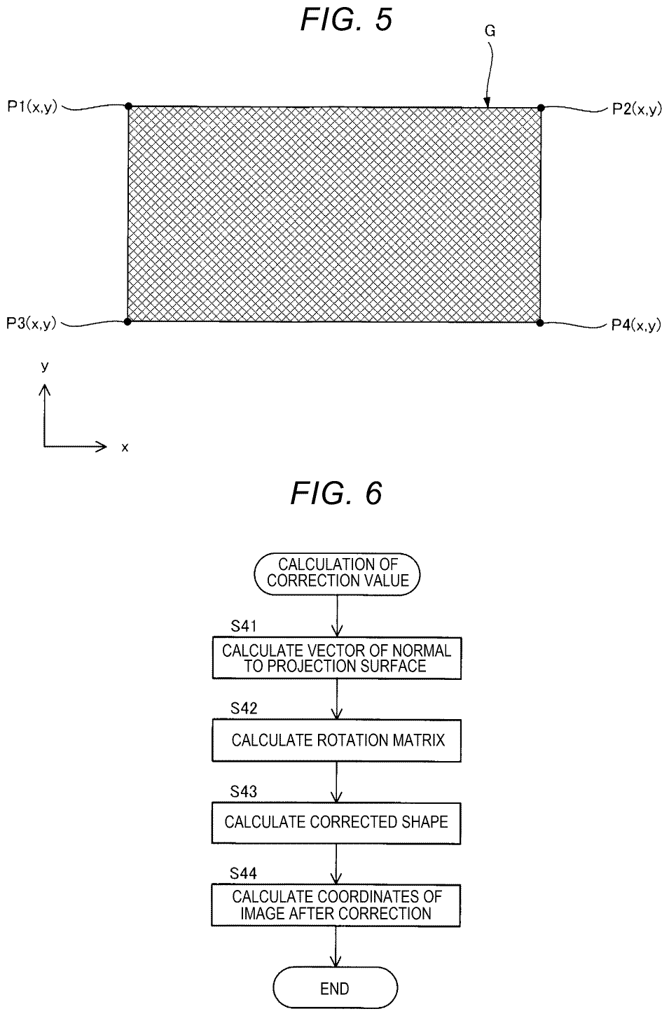

After step S30, the processing apparatus 12 calculates in step S40 corrected coordinates. The corrected coordinates are coordinate values of the four corners of the image G after the geometric correction. An example of a method for calculating the coordinate values will be described later with reference to FIGS. 5 and 6.

After step S40, the processing apparatus 12 in step S50 sets the corrected coordinates. The processing apparatus 12 writes the corrected coordinates produced in step S40 as the correction value information DC in the storage apparatus 11. The image processing circuit 14 performs the geometric correction with reference to the correction value information DC to perform the geometric correction based on the set corrected coordinates. In step S50, note that a statistical value such as the average of the corrected coordinates at multiple points of time may be set as each of the corrected coordinates used in the geometric correction.

After step S50, the processing apparatus 12 performs in step S60 focus setting. The focus setting is performed by acquiring the distance between the projector 10 and the projection surface SC based on the result of the detection performed by the distance sensor 17a, calculating the position of the lens of the projection system 15c based on the distance, and changing the position of the lens based on the result of the calculation.

After step S60, the processing apparatus 12 determines in step S70 whether to terminate the entire processes. The determination is made based, for example, on the user's operation performed on the projector 10.

When the processing apparatus 12 determines not to terminate the entire processes (NO in step S70), the processing apparatus 12 returns to step S10. Steps S10 to S60 are thus repeatedly executed in this order. On the other hand, when the processing apparatus 12 determines to terminate the entire processes (YES in step S70), the processing apparatus 12 terminates the entire processes.

FIG. 4 illustrates that the geometric correction is switched from one to another in the first embodiment. FIG. 4 shows the relationship between the projection angle θ, which is the angle between the horizontal plane H and the projection direction of the projector 10, and the pattern of the geometric correction to be applied. The projection surfaces SC-1 to SC-4 in the following description are imaginary surfaces specified for the processes carried out by the projector 10. It is assumed in the following description that the projection surfaces SC-1 to SC-4 are each a planar surface, that the projection surfaces SC-1 and SC-3 are surfaces parallel to the vertical direction, and that the projection surfaces SC-2 and SC-4 are surfaces perpendicular to the vertical direction. The assumption simplifies the processes carried out when the image G is geometrically corrected.

Due to the change in the posture of the projector 10 around the axis AX, the projector 10 takes any of the following states: a state in which the projector 10 projects the image G in such a way that the image G falls within any of the projection surfaces SC-1 to SC-4; a state in which the projector 10 projects the image G in such a way that the image G extends over the projection surfaces SC-1 and SC-2; a state in which the projector 10 projects the image G in such a way that the image G extends over the projection surfaces SC-2 and SC-3; a state in which the projector 10 projects the image G in such a way that the image G extends over the projection surfaces SC-3 and SC-4; and a state in which the projector 10 projects the image G in such a way that the image G extends over the projection surfaces SC-4 and SC-1.

When the image G is projected so as to fall within the projection surface SC-1, when the image G is projected so as to fall within the projection surface SC-2, when the image G is projected so as to fall within the projection surface SC-3, and when the image G is projected so as to fall within the projection surface SC-4, different geometric corrections are applied. Note that “applying the geometric correction” includes at least the process in step S40 carried out by the processing apparatus 12 to calculate the correction value information DC, and may include another process carried out by the processing apparatus 12 to execute step S40 or a process carried out by the image processing circuit 14 to perform the geometric correction on the image data IMG.

When the projection target is changed from one projection surface SC to another projection surface SC intersecting with the one projection surface SC out of the projection surfaces SC-1 to SC-4, it is necessary to switch the geometric correction to be applied from one to another. The reason for this is that, in the vicinity of the boundary between the projection surfaces SC, one of the upper and lower ends of the image G on the one projection surface SC is closer to the projector 10 than the other end, whereas the other of the upper and lower ends of the image G on the other projection surface SC is closer to the projector 10 than the one end, so that how to correct the image G needs to be changed. In this process, if the projection angle θ at which the geometric correction is switched when the projection target is changed from one of the one projection surface SC and the other projection surface SC to the other is equal to the projection angle θ at which the geometric correction is switched when the projection target is changed from the other surface to the one surface, the geometric correction is undesirably frequently switched. In other words, when the projection angle θ at which the geometric correction is switched is set at one fixed value, and when the image G is projected with the projection angle θ being close to the fixed value, the determination of the projection surface SC onto which the projection is performed frequently changes due, for example, to an error of the detection performed by the sensor 17, or vibration applied to the projector 10. As a result, the geometric correction is undesirably switched frequently.

To address the problem described above, in the projector 10, the projection angle θ at which the geometric correction is switched is made different in accordance with the direction in which projection direction changes.

Specifically, in step S20, the processing apparatus 12 determines the range to which the projection angle θ belongs out of the ranges RA1, RA2, RA3, RA4, RB1, RB2, RB3, and RB4, which differ from each other. The range RA1 is an example of a “first range”. The range RA2 is an example of a “second range” and is a range different from the range RA1. The range RB1 is an example of a “third range” and is a range between the ranges RA1 and RA2. The range between the ranges RA1 and RA2 is a range between an end point of the range RA1 and a start point of the range RA2 when the projection angle θ is rotated clockwise from an angle within the range RA1 to an angle within the range RA2 around the axis AX. An angle of boundary between the range RA1 and the range RB1 is included in either the range RA1 or the range RB1. An angle of boundary between the range RA2 and the range RB1 is included in either the range RA2 or the range RB1. An angle of boundary between the range RA2 and the range RB2 is included in either the range RA2 or the range RB2. An angle of boundary between the range RA3 and the range RB2 is included in either the range RA3 or the range RB2. An angle of boundary between the range RA3 and the range RB3 is included in either the range RA3 or the range RB3. An angle of boundary between the range RA4 and the range RB3 is included in either the range RA4 or the range RB3. An angle of boundary between the range RA4 and the range RB4 is included in either the range RA4 or the range RB4. An angle of boundary between the range RA1 and the range RB4 is included in either the range RA1 or the range RB4.

The range RA1 is a range containing an angle of 0°, and corresponds to geometric correction A for the image G to be projected onto the projection surface SC-1. The range RA2 is a range containing an angle of 90° and corresponds to geometric correction B for the image G to be projected onto the projection surface SC-2. The range RA3 is a range containing an angle of 180° and corresponds to geometric correction C for the image G to be projected onto the projection surface SC-3. The range RA4 is a range containing an angle of 270° and corresponds to geometric correction D for the image G to be projected onto the projection surface SC-4.

The range RB1 is the range between the range RA1 and the range RA2, and contains an angle α1. The angle α1 is determined in accordance with the projection angle θ at which the projection direction crosses the intersection line of the projection surface SC-1 and the projection surface SC-2, but is not limited to a specific angle, and is, for example, greater than or equal to 45° but smaller than or equal to 60°.

The range RB2 is the range between the range RA2 and the range RA3, and contains an angle α2. The angle α2 is determined in accordance with the projection angle θ at which the projection direction crosses the intersection line of the projection surface SC-2 and the projection surface SC-3, but is not limited to a specific angle, and is, for example, greater than or equal to 135° but smaller than or equal to 150°.

The range RB3 is the range between the range RA3 and the range RA4, and contains an angle α3. The angle α3 is determined in accordance with the projection angle θ at which the projection direction crosses the intersection line of the projection surface SC-3 and the projection surface SC-4, but is not limited to a specific angle, and is, for example, greater than or equal to 225° but smaller than or equal to 240°.

The range RB4 is the range between the range RA4 and the range RA1, and contains an angle α4. The angle α4 is determined in accordance with the projection angle θ at which the projection direction crosses the intersection line of the projection surface SC-4 and the projection surface SC-1, but is not limited to a specific angle, and is, for example, greater than or equal to 300° but smaller than or equal to 315°.

In the present embodiment, sizes β1, β2, β3, and β4 of the ranges RB1, RB2, RB3, and RB4 are each greater than 0° but smaller than or equal to 90°, preferably greater than or equal to 5° but smaller than or equal to 90°, more preferably, greater than or equal to 10° but smaller than or equal to 90°. The number of times of unintentional frequent switching of the geometric correction can therefore be preferably reduced. In the present embodiment, the sizes β1, β2, β3, and β4 are each smaller than 90°.

When the projection angle θ is an angle within the range RA1, the processing apparatus 12 applies in step S40 the geometric correction A for correcting the distortion of the image G to be projected from the projector 10 onto the projection surface SC-1. The geometric correction A is an example of “first geometric correction”, and includes a process using a variable representing the angle between the projection surface SC-1 and the projection direction. The degree of the geometric correction A therefore changes in accordance with the angle between the projection surface SC-1 and the projection direction. The image G to which appropriate geometric correction according to the projection angle θ has been applied can thus be projected onto the projection surface SC-1. The geometric correction A includes geometric correction A-1 and geometric correction A-2.

When the projection angle θ is an angle within the range RA2, the processing apparatus 12 applies in step S40 the geometric correction B for correcting the distortion of the image G to be projected from the projector 10 onto the projection surface SC-2. The geometric correction B is an example of “second geometric correction”, and includes a process using a variable representing the angle between the projection surface SC-2 and the projection direction. The degree of the geometric correction B therefore changes in accordance with the angle between the projection surface SC-2 and the projection direction. The image G to which appropriate geometric correction according to the projection angle θ has been applied can thus be projected onto the projection surface SC-2. The geometric correction B includes geometric correction B-1 and geometric correction B-2.

In the geometric correction A described above, it is necessary to calculate the vector of a normal to the projection surface SC based on the point group acquired in step S30, whereas in the geometric correction B, the direction of the gravitational acceleration is used as the vector of a normal to the projection surface SC in place of the acquisition of the point group and the calculation of the normal vector, as will be described later with reference to FIG. 6. The distance sensor 17a therefore does not perform measurement in the geometric correction B. In the geometric correction A, roll correction for correcting the distortion of the image G resulting from roll rotation, which is the rotation around the axis along the projection direction of the projector 10, is performed, whereas in the geometric correction B, the roll correction is not performed.

When the projection angle θ is an angle within the range RA3, the processing apparatus 12 applies in step S40 the geometric correction C for correcting the distortion of the image G to be projected from the projector 10 onto the projection surface SC-3. The geometric correction C includes a process using a variable representing the angle between the projection surface SC-3 and the projection direction. The degree of the geometric correction C therefore changes in accordance with the angle between the projection surface SC-3 and the projection direction. The image G to which appropriate geometric correction according to the projection angle θ has been applied can thus be projected onto the projection surface SC-3. The geometric correction C includes geometric correction C-1 and geometric correction C-2. Note in the geometric correction C that it is necessary to calculate the vector of a normal to the projection surface SC based on the point group acquired in step S30, as will be described later with reference to FIG. 6, as in the geometric correction A.

When the projection angle θ is an angle within the range RA4, the processing apparatus 12 applies in step S40 the geometric correction D for correcting the distortion of the image G to be projected from the projector 10 onto the projection surface SC-4. The geometric correction D includes a process using a variable representing the angle between the projection surface SC-4 and the projection direction. The degree of the geometric correction D therefore changes in accordance with the angle between the projection surface SC-4 and the projection direction. The image G to which appropriate geometric correction according to the projection angle θ has been applied can thus be projected onto the projection surface SC-4. The geometric correction D includes geometric correction D-1 and geometric correction D-2. Note in the geometric correction D that the direction of the gravitational acceleration is used as the vector of a normal to the projection surface SC, as in the geometric correction B.

When the projection angle θ changes from an angle within the range RA1 to an angle within the range RB1, the processing apparatus 12 applies the geometric correction A-2 of the geometric correction A in step S40. When the projection angle θ changes from an angle within the range RA2 to an angle within the range RB1, the processing apparatus 12 applies the geometric correction B-1 of the geometric correction B in step S40.

When the projection angle θ changes from an angle within the range RA2 to an angle within the range RB2, the processing apparatus 12 applies the geometric correction B-2 of the geometric correction B in step S40. When the projection angle θ changes from an angle within the range RA3 to an angle within the range RB2, the processing apparatus 12 applies the geometric correction C-1 of the geometric correction C in step S40.

When the projection angle θ changes from an angle within the range RA3 to an angle within the range RB3, the processing apparatus 12 applies the geometric correction C-2 of the geometric correction C in step S40. When the projection angle θ changes from an angle within the range RA4 to an angle within the range RB3, the processing apparatus 12 applies the geometric correction D-1 of the geometric correction D in step S40.

When the projection angle θ changes from an angle within the range RA4 to an angle within the range RB4, the processing apparatus 12 applies the geometric correction D-2 of the geometric correction D in step S40. When the projection angle θ changes from an angle within the range RA1 to an angle within the range RB4, the processing apparatus 12 applies the geometric correction A-1 of the geometric correction A in step S40.

As described above, since the projection angle θ at which the geometric correction is switched varies in accordance with the direction in which the projection direction changes, the number of times of unintentional frequent switching of the geometric correction can be reduced as compared with an aspect in which the geometric correction is switched at the same projection angle θ irrespective of the direction in which the projection direction changes. In other words, even when the projection angle θ changes from an angle within any of the ranges RA1, RA2, RA3, and RA4 to an angle within any of the ranges RB1, RB2, RB3, and RB4, the geometric correction applied before the projection angle θ changes is applied until the projection angle θ reaches any of the ranges RA1, RA2, RA3, and RA4 that differs from the range within which the projection angle θ falls before the projection angle θ changes. As described above, the projection angle θ at which the geometric correction is switched has hysteresis, that is, the projection angle θ varies in accordance with the direction in which the projection angle θ changes.

When the projection angle θ changes from an angle within the range RB1 to an angle within the range RA2, the processing apparatus 12 applies the geometric correction B-1 of the geometric correction B in step S40. Therefore, when the projection angle θ changes from an angle within the range RA1 to an angle within the range RA2 via the range RB1, the image G to which the geometric correction B has been applied can be projected from the projector 10 onto the projection surface SC-2.

When the projection angle θ changes from an angle within the range RB1 to an angle within the range RA1, the processing apparatus 12 applies the geometric correction A-2 of the geometric correction A in step S40. Therefore, when projection angle θ changes from an angle within the range RA2 to an angle within the range RA1 via the range RB1, the image G to which the geometric correction A has been applied can be projected from the projector 10 onto the projection surface SC-1.

Similarly, when the projection angle θ changes from an angle within the range RB2 to an angle within the range RA3, the processing apparatus 12 applies the geometric correction C in step S40. When the projection angle θ changes from an angle within the range RB2 to an angle within the range RA2, the processing apparatus 12 applies the geometric correction B in step S40. When the projection angle θ changes from an angle within the range RB3 to an angle within the range RA4, the processing apparatus 12 applies the geometric correction D in step S40. When the projection angle θ changes from an angle within the range RB3 to an angle within the range RA3, the processing apparatus 12 applies the geometric correction C in step S40. When the projection angle θ changes from an angle within the range RB4 to an angle within the range RA1, the processing apparatus 12 applies the geometric correction A in step S40. When the projection angle θ changes from an angle within the range RB4 to an angle within the range RA4, the processing apparatus 12 applies the geometric correction D in step S40.

FIG. 5 illustrates the correction value. In the present embodiment, the image G has a rectangular shape, and coordinate values P1 (x, y), P2 (x, y), P3 (x, y), and P4 (x, y) of the four corners of the image G are calculated as the correction value in step S40, as shown in FIG. 5. The coordinate values are those of the display coordinate system set in the optical apparatus 15, or a coordinate system associated with the display coordinate system. The coordinate values are therefore associated with the pixels of the optical apparatus 15. An example of a method for calculating the correction value will be briefly described below. Note that the following method for calculating the correction value is an example and is not limited thereto, and various known calculation methods may, for example, be used.

FIG. 6 is a flowchart showing an example of the method for calculating the correction value. In step S40, the processing apparatus 12 first in step S41 acquires a depth map of the projection surface SC based on the point group acquired in step S30, determines the equation of the projection surface SC from the depth map, and then calculates the vector of a normal to the projection surface SC as a variable based on the determined equation, as shown in FIG. 6.

The processing apparatus 12 then calculates in step S42 a rotation matrix representing the rotation of the projection surface SC viewed from the projector 10 in the projection direction based on the vector of the normal to the projection surface SC and the direction of the gravitational acceleration acting on the projector 10.

The processing apparatus 12 then calculates in step S43 a corrected shape as the shape of the image G projected so as to face the projection surface SC.

The processing apparatus 12 then calculates in step S44 the coordinate values P1 (x, y), P2 (x, y), P3 (x, y), and P4 (x, y) of the four corners of the image G as the coordinates of the image G after the correction by using the rotation matrix calculated in step S42 and the corrected shape calculated in step S43.

By using the calculation method described above, the image G to be projected onto the projection surface SC can be automatically geometrically corrected in real time by using the result of the detection performed by the sensor 17.

As described above, in the first embodiment, since the projection angle θ at which the geometric correction is switched varies in accordance with the direction in which the projection direction changes, the number of times of unintentional frequent switching of the geometric correction can be reduced as compared with the aspect in which the geometric correction is switched at the same projection angle θ irrespective of the direction in which the projection direction changes.

### 2. Second Embodiment

A second embodiment of the present disclosure will be described below. In the embodiment described below by way of example, elements providing the same effects and having the same functions as those in the first embodiment have the same reference characters used in the description of the first embodiment, and will not be described in detail as appropriate.

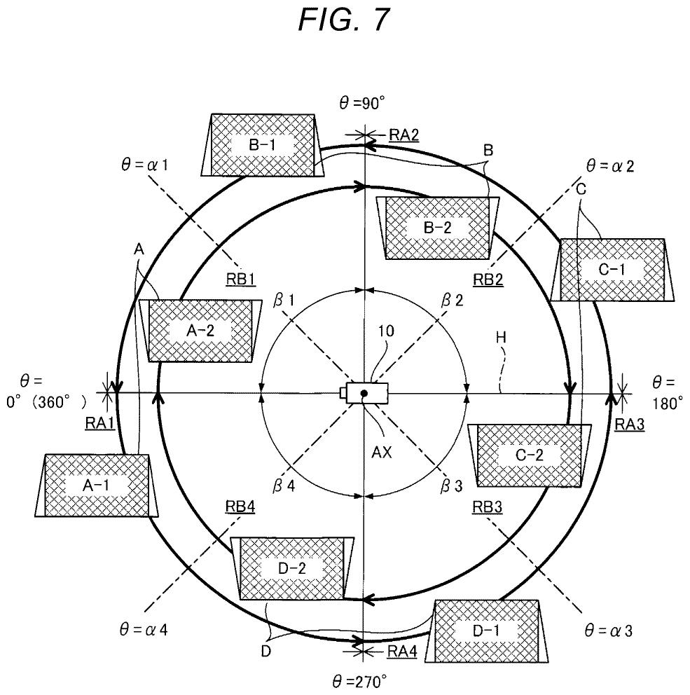

FIG. 7 illustrates that the geometric correction is switched from one to another in the second embodiment. The present embodiment is the same as the first embodiment except that the sizes β1, β2, β3, and β4 of the ranges RB1, RB2, RB3, and RB4 are each 90°. The size of each of the ranges RA1, RA2, RA3, and RA4 is therefore substantially 0°.

In the present embodiment, when the projection angle θ is 0°, the processing apparatus 12 determines that the projection angle θ is an angle within the range RA1. When the projection angle θ is 90°, the processing apparatus 12 determines that the projection angle θ is an angle within the range RA2. When the projection angle θ is 180°, the processing apparatus 12 determines that the projection angle θ is an angle within the range RA3. When the projection angle θ is 270°, the processing apparatus 12 determines that the projection angle θ is an angle within the range RA4. Therefore, for example, when the projection angle θ is changed in the direction in which the projection angle θ increases from 0° as the initial state, the geometric correction A is applied in the range over which the projection angle θ is smaller than 90°. When the projection angle θ becomes 90° or greater, the geometric correction B is applied. When the geometric correction B is applied, and when the projection angle θ is changed in the direction in which the projection angle decreases, the geometric correction B is applied in a range over which the projection angle θ is greater than 0°, and the geometric correction A is applied when the projection angle θ becomes 0° or smaller than 360°.

The second embodiment described above also allows reduction in the number of times of unintentional frequent switching of the geometric correction. The present embodiment is also advantageous in that a small change in the projection angle θ suffices for switching the geometric correction. The present embodiment further allows an increase in the width of the range of the projection angle θ at which the multiple types of geometric correction are each applicable. Note that the size of each of the ranges RA1, RA2, RA3, and RA4 may be greater than or equal to about 1° but smaller than or equal to about 5°.

### 3. Variations

The embodiments shown above by way of example can be changed in various manners. Specific aspects of the variations applicable to the embodiments described above will be shown below by way of example. Two or more aspects freely selected from the examples below can be combined with each other as appropriate to the extent that no contradiction occurs.

### 3-1. Variation 1

In the embodiments described above, the aspect in which the image G can be projected onto the projection surfaces SC-1 to SC-4 is presented by way of example, but not limited thereto. For example, the projection of the image G onto the projection surfaces SC-3 and SC-4 may be omitted.

### 3-2. Variation 2

The aforementioned embodiments have been described on the assumption that the projection surface SC-1 is the “first projection surface” and the projection surface SC-2 is the “second projection surface”, but not limited thereto, and it can be assumed that one of any two projection surfaces SC adjacent to each other out of the projection surfaces SC-1 to SC-4 is the “first projection surface” and the other projection surface SC as the “second projection surface”. In this case, the projection of the image G onto the projection surface SC that corresponds to neither the “first projection surface” nor the “second projection surface” may be omitted.

### 4. Additional Remarks

The present disclosure will be summarized below as additional remarks.

(Additional remark 1) A first aspect that is a preferable example of a correction method according to the present disclosure relates to a correction method including: applying first geometric correction for correcting distortion of an image to be projected from a projector onto a first projection surface when a projection angle that is an angle between a horizontal plane and a projection direction of the projector is an angle within a first range; applying second geometric correction for correcting distortion of an image to be projected from the projector onto a second projection surface that intersects with the first projection surface when the projection angle is an angle within a second range different from the first range; applying the first geometric correction when the projection angle changes from an angle within the first range to an angle within a third range that is a range between the first range and the second range; and applying the second geometric correction when the projection angle changes from an angle within the second range to an angle within the third range.

In the aspect described above, since the projection angle at which the geometric correction is switched varies in accordance with the direction in which the projection direction changes, the number of times of unintentional frequent switching of the geometric correction can be reduced as compared with an aspect in which the geometric correction is switched at the same projection angle irrespective of the direction in which the projection direction changes.

(Additional remark 2) In a second aspect that is a preferable example of the first aspect, the correction method further includes applying the second geometric correction when the projection angle changes from an angle within the third range to an angle within the second range. In the aspect described above, when the projection angle changes from an angle within the first range to an angle within the second range via the third range, the image to which the second geometric correction has been applied can be projected from the projector onto the second projection surface.

(Additional remark 3) In a third aspect that is a preferable example of the first or second aspect, the method further includes applying the first geometric correction when the projection angle changes from an angle within the third range to an angle within the first range. In the aspect described above, when the projection angle changes from an angle within the second range to an angle within the first range via the third range, the image to which the first geometric correction has been applied can be projected from the projector onto the first projection surface.

(Additional remark 4) In a fourth aspect that is a preferable example of any of the first to third aspects, the first geometric correction includes a process using a variable representing an angle between the first projection surface and the projection direction, and the second geometric correction includes a process using a variable representing an angle between the second projection surface and the projection direction. In the aspect described above, an image to which appropriate geometric correction according to the projection angle has been applied can be projected onto each of the first and second projection surfaces.

(Additional remark 5) In a fifth aspect that is a preferable example of any of the first to fourth aspects, the third range is greater than 0° but smaller than or equal to 90°. In the aspect described above, the number of times of unintentional frequent switching of the geometric correction can be preferably reduced.

(Additional remark 6) In a sixth aspect that is a preferable example of any of the first to fifth aspects, the first projection surface is a surface parallel to a vertical direction, and the second projection surface is a surface perpendicular to the vertical direction. In the aspect described above, a wall surface or a screen or the like along the wall surface can be the first projection surface, and a ceiling surface or a screen or the like along the ceiling surface can be the second projection surface.

(Additional remark 7) A seventh aspect that is a preferable example of a projector according to the present disclosure relates to a projector including an optical apparatus; and at least one processor configured to apply first geometric correction for correcting distortion of an image to be projected from the optical apparatus onto a first projection surface when a projection angle that is an angle between a horizontal plane and a projection direction of the optical apparatus is an angle within a first range, apply second geometric correction for correcting distortion of an image to be projected from the optical apparatus onto a second projection surface that intersects with the first projection surface when the projection angle is an angle within a second range different from the first range, apply the first geometric correction when the projection angle changes from an angle within the first range to an angle within a third range that is a range between the first range and the second range, and apply the second geometric correction when the projection angle changes from an angle within the second range to an angle within the third range.

In the aspect described above, since the projection angle at which the geometric correction is switched varies in accordance with the direction in which the projection direction changes, the number of times of unintentional frequent switching of the geometric correction can be reduced as compared with the aspect in which the geometric correction is switched at the same projection angle irrespective of the direction in which the projection direction changes.

(Additional remark 8) An eighth aspect that is a preferable example of a non-transitory computer-readable storage medium storing a program according to the present disclosure relates to a non-transitory computer-readable storage medium storing a program, configured to cause at least one processor to apply first geometric correction for correcting distortion of an image to be projected from a projector onto a first projection surface when a projection angle that is an angle between a horizontal plane and a projection direction of the projector is an angle within a first range, apply second geometric correction for correcting distortion of an image to be projected from the projector onto a second projection surface that intersects with the first projection surface when the projection angle is an angle within a second range different from the first range, apply the first geometric correction when the projection angle changes from an angle within the first range to an angle within a third range that is a range between the first range and the second range, and apply the second geometric correction when the projection angle changes from an angle within the second range to an angle within the third range.

In the aspect described above, since the projection angle at which the geometric correction is switched varies in accordance with the direction in which the projection direction changes, the number of times of unintentional frequent switching of the geometric correction can be reduced as compared with the aspect in which the geometric correction is switched at the same projection angle irrespective of the direction in which the projection direction changes.

What is claimed is:

1. A correction method comprising:
applying first geometric correction for correcting distortion of an image to be projected from a projector onto a first projection surface when a projection angle that is an angle between a horizontal plane and a projection direction of the projector is an angle within a first range;
applying second geometric correction for correcting distortion of an image to be projected from the projector onto a second projection surface that intersects with the first projection surface when the projection angle is an angle within a second range different from the first range;
applying the first geometric correction when the projection angle changes from an angle within the first range to an angle within a third range that is a range between the first range and the second range; and
applying the second geometric correction when the projection angle changes from an angle within the second range to an angle within the third range.

2. The correction method according to claim 1, further comprising
applying the second geometric correction when the projection angle changes from an angle within the third range to an angle within the second range.

3. The correction method according to claim 1, further comprising
applying the first geometric correction when the projection angle changes from an angle within the third range to an angle within the first range.

4. The correction method according to claim 1, wherein
the first geometric correction includes a process using a variable representing an angle between the first projection surface and the projection direction, and
the second geometric correction includes a process using a variable representing an angle between the second projection surface and the projection direction.

5. The correction method according to claim 1, wherein
the third range is greater than 0° but smaller than or equal to 90°.

6. The correction method according to claim 1, wherein
the first projection surface is a surface parallel to a vertical direction, and
the second projection surface is a surface perpendicular to the vertical direction.

7. A projector comprising:
an optical apparatus; and
at least one processor configured to apply first geometric correction for correcting distortion of an image to be projected from the optical apparatus onto a first projection surface when a projection angle that is an angle between a horizontal plane and a projection direction of the optical apparatus is an angle within a first range,
apply second geometric correction for correcting distortion of an image to be projected from the optical apparatus onto a second projection surface that intersects with the first projection surface when the projection angle is an angle within a second range different from the first range,
apply the first geometric correction when the projection angle changes from an angle within the first range to an angle within a third range that is a range between the first range and the second range, and
apply the second geometric correction when the projection angle changes from an angle within the second range to an angle within the third range.

8. A non-transitory computer-readable storage medium storing a program, configured to cause at least one processor to
apply first geometric correction for correcting distortion of an image to be projected from a projector onto a first projection surface when a projection angle that is an angle between a horizontal plane and a projection direction of the projector is an angle within a first range,
apply second geometric correction for correcting distortion of an image to be projected from the projector onto a second projection surface that intersects with the first projection surface when the projection angle is an angle within a second range different from the first range,
apply the first geometric correction when the projection angle changes from an angle within the first range to an angle within a third range that is a range between the first range and the second range, and
apply the second geometric correction when the projection angle changes from an angle within the second range to an angle within the third range.
